(19) United States
(12) Patent Application Publication
(10) Pub. No.: US 2008/0138646 A1
(43) Pub. Date: Jun. 12, 2008

(54) Metal-Reinforced Hybrid Structure

(75) Inventors: Jeroen Frankenmolen, Eindhoven (NL); Jochen Zimmermann, Wuppertal (DE); Volkmar Geiermann, Koln (DE); Wolfgang Krisch, Leichlingen (DE)

Correspondence Address: FOLEY AND LARDNER LLP;SUITE 500, 3000 K STREET NW, WASHINGTON, DC, 20007, US

(73) Assignee: Johnson Controls Interiors GmbH & Co. KG

(21) Appl. No.: 11/795,013

(22) PCT Filed: Jan. 11, 2006
(86) PCT No.: PCT/EP06/50161

§ 371 Date: Oct. 9, 2007

(30) Foreign Application Priority Data
Jan. 11, 2005 (DE) 10 2005 001 367.8

(51) Int. Cl. B32B 15/00; B29C 45/00; B23K 26/20; B21D 39/00

(52) U.S. Cl. 428/621; 264/328.1; 219/121.64; 29/428

(57) ABSTRACT

A component with a hybrid structure includes a metal part partially surrounded by at least one polymer component. The metal part has at least one connecting region. The component also includes a metal reinforcement. The metal part is connected to metal reinforcement at the at least one connecting region. A method for producing such a component includes providing a metal part having at least one connecting region, at least partially surrounding the metal part by at least one polymer component, providing a metal reinforcement and connecting the metal part and the metal reinforcement at the at least one connecting region in one of a positive, non-positive and material fit.

### CROSS-REFERENCE TO RELATED PATENT APPLICATIONS

The present application is a National Stage of International Application No. PCT/EP2006/050161 filed on Jan. 11, 2006, which claims the benefit of German Patent Application No. 10 2005 001 367.8 filed on Jan. 11, 2005. The entire disclosures of International Application No. PCT/EP2006/050161 and German Patent Application No. 10 2005 001 367.8 are incorporated herein by reference.

### BACKGROUND

The present disclosure relates to a component with a hybrid structure. Furthermore, the present disclosure relates to a method for producing a component with a hybrid structure.

Plastic/metal composite parts, hereinafter referred to as hybrid structures, are employed in the automotive sector. In particular, hybrid structures are often used for parts with large surface areas. Known examples of hybrid structures are disclosed in DE 44 37 773 and EP 0 721 831 B1. However, these known hybrid structures often do not exhibit sufficient mechanical strength. Therefore, there continues to be a need for a component with a hybrid structure that does not exhibit the disadvantages of the prior art.

### SUMMARY

One exemplary embodiment relates to a component with a hybrid structure. The component includes a metal part at least partially surrounded by at least one polymer component. The metal part has at least one connecting region. The component also includes a metal reinforcement. The metal part is connected to metal reinforcement at the at least one connecting region.

Another exemplary embodiment relates to a method for producing a component. The method includes providing a metal part having at least one connecting region, at least partially surrounding the metal part by at least one polymer component, providing a metal reinforcement and connecting the metal part and the metal reinforcement at the at least one connecting region in at least one of a positive, non-positive and material fit.

### BRIEF DESCRIPTION OF THE DRAWINGS

FIG. 1 is a cross sectional view of a component according to an exemplary embodiment.

FIG. 2 is a cross sectional view of a component according to another exemplary embodiment.

FIG. 3 is a perspective view of a component according to another exemplary embodiment.

FIG. 4 is a perspective view of a component according to another exemplary embodiment.

FIG. 5 is a perspective view of a component according to another exemplary embodiment.

### DETAILED DESCRIPTION

It was extremely surprising and not to be expected for persons skilled in the art that practically any desired mechanical strengths can be achieved with the component of the present disclosure. The component of the present disclosure is simple and inexpensive to manufacture.

According to an exemplary embodiment, a component includes a hybrid structure. For purposes of the present disclosure, the phrase “hybrid structure” is used broadly to refer to a plastic/metal composite part. Practically any metal known to a person skilled in the art can be used as the metal in the hybrid structure. According to an exemplary embodiment, these metals are metals that are weldable (e.g., iron, steel and/or aluminum). The metal is at least partly connected to a polymer component. Such a connection can be a positive, non-positive or material fit. All customary polymerized compounds known to a person skilled in the art can be used as the polymer component. According to an exemplary embodiment, the polymer component is a thermoplastic polymer or plastic blend. In particular, the polymer component may be a thermoplastic polymer or plastic blend that contains polycarbonate, polyamide, polyester, ABS and/or polypropylene. According to an exemplary embodiment, the polymer component contains a reinforcing agent. For example, the polymer component may contain glass fibers. In order to improve the material bond between the metal part and the polymer component, the metal part can be pretreated (e.g., with a coupling agent or an adhesive layer). For example, a foil may be arranged (e.g., press or roll) onto the metal part. The polymer component is then arranged on the metal part. The foil is intended to melt during its coating with the polymer component and act as a coupling agent.

According to an exemplary embodiment, the metal part is not completely surrounded by the polymer component and includes at least one region that is not surrounded by the polymer component and that is connected to a metal reinforcement. The connection to the metal reinforcement can be a positive, non-positive or material fit. According to an exemplary embodiment, the metal reinforcement is welded to the metal part (e.g., by laser welding). Laser welding has the advantage that relatively little heat is created during welding so that the polymer component is not impaired or is impaired to only a slight extent during welding. By using laser welding, it is even possible for the metal part and the metal reinforcement to be welded together through the polymer component. In such a situation, the laser beam passes through the polymer component. Such an embodiment may be particularly suitable for hybrid structures with a thin layer of the polymer component.

According to an exemplary embodiment, the region accessible for a connection (e.g., a welding connection, such as a laser welding connection) between the metal part and the metal reinforcement is arranged in the edge region of the metal part. According to another exemplary embodiment, the region comprises a recess or several recesses. These recesses can also be created during the connection, for example during the laser welding.

The metal reinforcement can have any desired form required in each case to give the component the desired mechanical properties. According to an exemplary embodiment, the metal reinforcement has a profiled cross section.

According to an exemplary embodiment, a method for producing a component in which the metal part and the metal reinforcement are connected together in a positive, non-positive or material fit can be performed simply and inexpensively. According to an exemplary embodiment, the connection is a material fit achieved by bonding or welding. For example, the connection may be achieved by laser welding. Laser welding has the advantage of a low heat development so that the polymer component is not damaged or is damaged to only a slight extent. According to an exemplary embodiment, the metal part and the metal reinforcement are connected together (e.g., welded) after the metal part has been surrounded by the polymer component. In such an embodiment, the material fit connection between the metal part and the metal reinforcement is effected through the polymer component (e.g., by directing a laser beam through the polymer component).

Exemplary embodiments are explained in more detail below by reference to FIGS. 1-5. These explanations are only exemplary and do not limit the scope of the disclosure. The explanations apply equally to a component having a hybrid structure and to a method of producing a component having a hybrid structure.

FIG. 1 shows a component 1 according to an exemplary embodiment. The component 1 has a hybrid structure 8 that includes a metal reinforcement 4. The hybrid structure 8 includes a metal part 2 that is partially surrounded by a polymer component 3. According to an exemplary embodiment, the polymer component 3 is a plastic. Edge regions 5 of the metal part 2 are not surrounded by the polymer component 3 and can be connected to the metal reinforcement 4 in a positive, non-positive or material fit. According to the embodiment illustrated, the edge regions 5 and the metal reinforcement 4 are welded together (e.g., by laser welding).

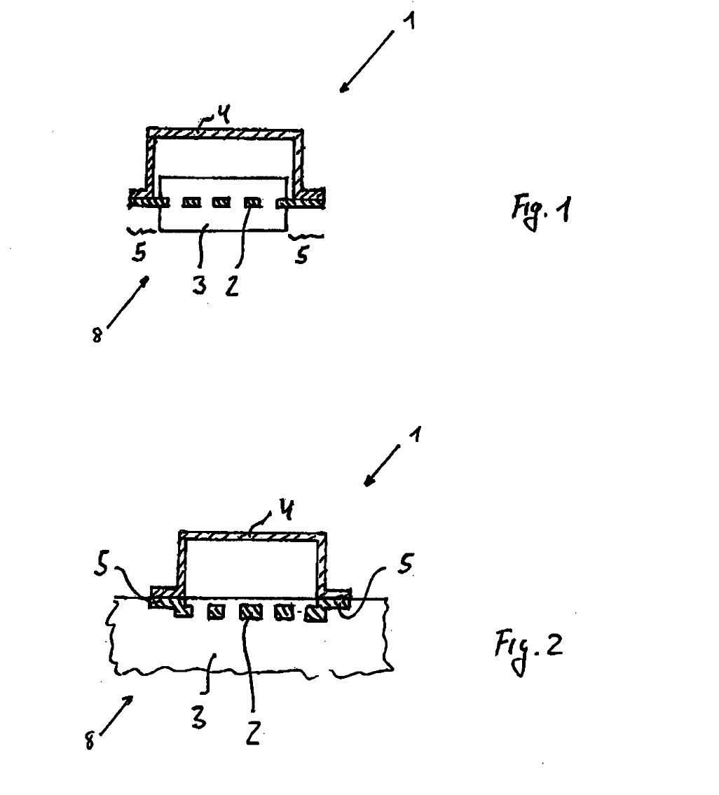

FIG. 2 shows a component according to another exemplary embodiment. The component 1 of FIG. 2 is similar to the component 1 of FIG. 1 with the distinction that in this example, the metal part 2 is in an edge region of the polymer component 3 and not in the middle of the polymer component 3. The edge regions 5 of the metal part 2 and the upper side of the polymer component 3 end flush with one another. According to the embodiment illustrated, the edge regions 5 of the metal part 2 are welded to the metal reinforcement 4.

FIG. 3 shows a component 1 according to another exemplary embodiment. According to the embodiment illustrated, a metal plate 2 is surrounded on the right and left, with the exception of region 5, by a polymer component 3. In this edge region 5, the metal plate 2 is welded to a metal reinforcement 4 (e.g., by laser welding).

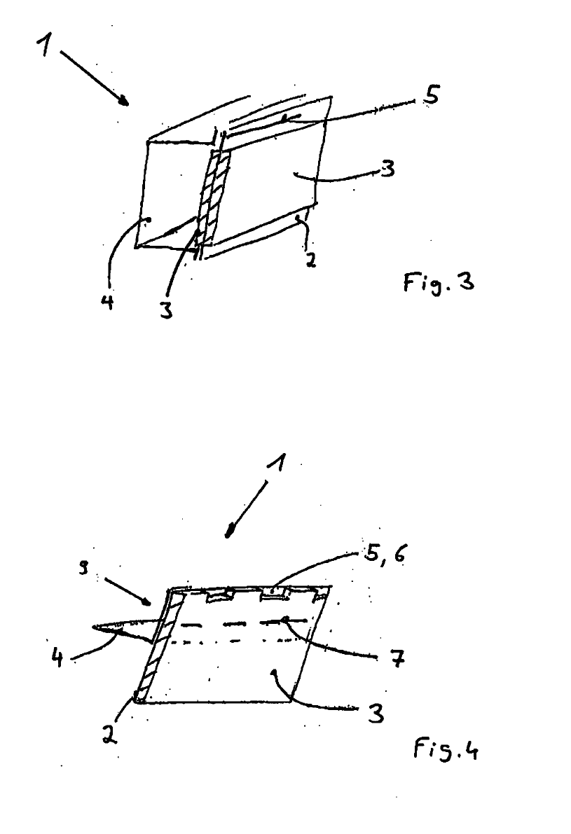

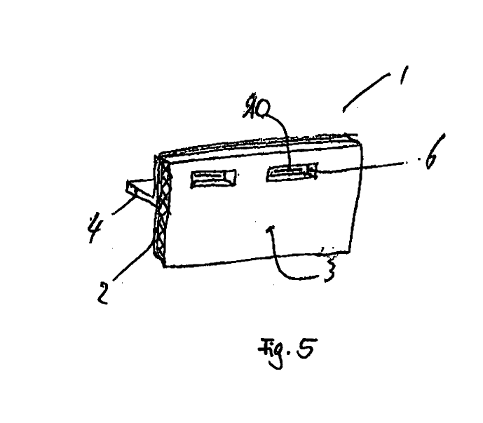

FIG. 4 shows a component 1 according to another exemplary embodiment. According to the embodiment illustrated, a metal plate 2 is coated on its rear side with a polymer component 3 that in its upper region has recesses 6. These recesses 6 represent the region 5 in which the plate 2 can be connected to a reinforcement 4 with a material fit (e.g., by laser welding). Furthermore, the plate 2 is welded both to the metal reinforcement 4 and in the lower region. Welding is performed from the direction indicated by the arrow 9. This welding leaves the fusion indicated with the reference number 7 in the polymer component.

FIG. 5 shows a component 1 according to another exemplary embodiment. The exemplary embodiment illustrated in FIG. 5 is similar to the exemplary embodiment illustrated in FIG. 4, except that in embodiment illustrated in FIG. 5, the recess is located further down and no longer at the edge. A weld seam 10 produced with a laser which connects metal part 2 and metal reinforcement 4 together can be seen through the recess 6.

1. A component with a hybrid structure, the component comprising:
a metal part at least partially surrounded by at least one polymer component, the metal part having at least one connecting region; and
a metal reinforcement,
wherein the metal part is connected to metal reinforcement at the at least one connecting region.

2. The component of claim 1 wherein the metal reinforcement is connected to the metal part with a material fit.

3. The component of claim 1 wherein the at least one polymer component and the metal part are connected together in one of a positive, non-positive and material fit.

4. The component of claim 1 wherein the at least one connecting region is arranged in an edge region of the metal part.

5. The component of claim 1 wherein the polymer component defines a recess at the at least one connecting region.

6. The component of claim 1 wherein the metal reinforcement has a profiled cross section.

7. A method for producing a component, the method comprising:
providing a metal part having at least one connecting region;
at least partially surrounding the metal part by at least one polymer component;
providing a metal reinforcement; and
connecting the metal part and the metal reinforcement at the at least one connecting region in at least one of a positive, non-positive and material fit.

8. The method of claim 7 wherein the metal part and the metal reinforcement are welded together.

9. The method of claim 7 wherein the metal part and the metal reinforcement are connected together after the metal part has been connected to the polymer component.

10. The method of claim 7 wherein the metal part is surrounded with the polymer component by at least one of injection molding and forming.

11. The method of claim 7 wherein the connection between the metal part and the metal reinforcement is a material fit.

12. The method of claim 11 wherein the connection between the metal part and the metal reinforcement is made through the polymer component.

13. The component of claim 2 wherein the metal reinforcement is connected to the metal part by welding.

14. The component of claim 13 wherein the metal reinforcement is connected to the metal part by laser welding.

15. The method of claim 8 wherein the metal part and the metal reinforcement are welded together by laser welding.

16. A component comprising:
a metal part having at least one connecting region;
a polymer component at least partially surrounding the metal part; and
a metal reinforcement connected to the metal part at the at least one connecting region,
wherein the metal reinforcement is connected to the metal part by a weld seam.

17. The component of claim 16 wherein the metal part is positioned at an edge region of the polymer component.

18. The component of claim 17 wherein the at least one connecting region is substantially flush with an upper side of the polymer component.

19. The component of claim 16 wherein the polymer component defines at least one recess corresponding to the at least one connecting region of the metal part.

20. The component of claim 19 wherein the at least one recess is provided in an upper region of the polymer component.
